(19) United States
(12) Patent Application Publication
(10) Pub. No.: US 2005/0181694 A1
(43) Pub. Date: Aug. 18, 2005

(54) Industrial fabrics

(76) Inventors: Robert L. Crook, Wilson, NC (US); William Daniel Aldrich, Wilson, NC (US); Sanjay Patel, Summerville, SC (US)

Correspondence Address: Todd T. Taylor;Taylor & Aust, P.C., 142 S. Main Street, P.O. Box 560, Avilla, IN, 46710, US

(21) Appl. No.: 10/934,687

(22) Filed: Sep. 3, 2004

Related U.S. Application Data
(63) Continuation of application No. PCT/EP03/02375, filed on Mar. 7, 2003.

(30) Foreign Application Priority Data
Mar. 9, 2002 (GB) 0205574.7

(51) Int. Cl. B32B 5/26; D04H 1/46; B32B 27/12; D04H 5/02; B32B 5/06

(52) U.S. Cl. 442/270; 442/402; 442/394; 442/268; 442/286

(57) ABSTRACT

An industrial fabric including a base layer, a batt layer and at least one low-melt polymeric film layer, which has been needled into the batt layer and subsequently thermoformed to at least partially encapsulate the fibers of the batt layer.

### CROSS REFERENCE TO RELATED APPLICATIONS

This is a continuation of PCT application No. PCT/EP03/02375, entitled “INDUSTRIAL FABRICS”, filed Mar. 7, 2003.

### BACKGROUND OF THE INVENTION

1. Field of the Invention

The present invention relates to industrial fabrics for use in phase separation applications such as media for filtration and fabrics for papermaking.

2. Description of the Related Art

When in use, industrial fabrics suffer from the problems of fiber shedding and wear. Also, rewetting of a paper sheet, upon exit of the sheet from the press-nip of the papermaking machine, is a recognized problem. Various methods of alleviating these drawbacks have been proposed.

In the papermaking felt described in U.S. Pat. No. 5,372,876 (Appleton Mills), at least one hydrophobic layer of co-joined synthetic, such as nylon filaments, is disposed between a base fabric and the batt material and/or between at least two batt layers. The various layers are joined by needling. In use, the batt layer receives water from the web, and such water is forced from the batt layer through the hydrophobic layer(s) under pressure in the press-nip. Upon exiting the press-nip, the pressure is relieved and the hydrophobic layer provides a barrier, which reduces backflow of water to the batt, thereby alleviating rewetting.

In Patent No. GB 2,285,935 (Scapa Group) the problem of fiber shedding and wear is addressed by providing a polymer coated paper machine clothing, which reduces fiber shedding and improves both abrasion resistance and surface smoothness. The coating is applied by urging a polymer film coated release sheet onto the surface of the base cloth of the fabric, curing the polymer by passing it through a heated roller and then removing the release sheet to leave a permeable coating.

In U.S. Pat. No. 5,118,557 (Albany) a thin layer of polymer foam is applied to the surface of the press fabric, which is allowed to dry, this procedure is repeated several times to form a coating. This fabric then has an increased resistance to rewet of the paper and produces a paper sheet with increased surface smoothness, due to increased surface contact area afforded by the foam coating together with its controlled porosity and void volume.

In EP 0239207 (Asten) a 0.4 mm thick scrim of low melt synthetic material having a regular lattice configuration of 6 mm squares is located between two upper batt layers of a papermaker's felt. The lattice structure is designed in order not to affect the moisture absorption of the felt and is provided to prevent excessive fiber migration as a result of the needling operation to join the various batt layers together. In a subsequent heat setting step the scrim, which has a lower melting point than that of the batt material, is softened to undergo deformation thereby adhering to the batt fibers and reducing the likelihood of fiber migration or layer separation of the batt during use of the papermaker's felt.

In U.S. Pat. No. 4,199,401 (Asten) a coarse layer of batt is provided on the paper contacting side, and a finer denier batt is sandwiched between this and a base layer of the papermaker's felt. This allows the water to migrate through the felt by capillary action thereby reducing rewet.

In U.S. Pat. No. 5,232,768 (Nordiskafilt) a batt layer is provided on the paper contacting side, and a barrier layer is sandwiched between this and the base layer of the press felt. The barrier layer may include filament threads as a perforated film or sintered polymeric particles as a foam layer. The barrier layer provides a high resistance to water flowing back through it to the paper contacting side.

In U.S. Pat. No. 5,071,697 (Gulya) a permeable polymeric foam is secured to the surface of a base substrate, with a thin outer layer of polymeric film being bonded to the outer surface. This provides a flexible, tough skin to resist abrasion and tearing during operation.

In U.S. Pat. No. 4,830,905 (Gulya) a method to reduce web rewet is described having a layer of closed cell polymeric foam disposed on a face of the base fabric. A fibrous batt layer is needled thereon, this needling action penetrates the foam and intersects the cells. Whilst compressed in the nip, the penetrated cell walls open up allowing water in, then upon leaving the nip, the walls close, thereby trapping water in the cells.

U.S. Pat. No. 3,214,326 (Lee) describes a press felt, the objective of which is to increase the quantity of water removed from the paper sheet, as well as to reduce rewet. A barrier layer is attached to the upper, paper contacting surface of a woven base cloth. The barrier layer is a fine, low permeability, woven fabric.

U.S. Pat. No. 3,399,111 (Beaumont) describes a ‘supplemental belt’, for use in conjunction with a press felt, which runs on the machine-side. The construction includes at least one perforated film laminated to a foam or woven layer. One of the belt's purposes is to give good drainage and water removal characteristics.

U.S. Pat. No. 4,541,895 (Albert) describes a papermaker's fabric made up of a plurality of perforated plastic sheets, the size and distribution of the apertures being variable.

U.S. Pat. No. 4,550,588 (Lundstrom) describes an air impermeable felt/belt which has been manufactured by filling a felt, except for the upper surface, which retains a chamois-like surface. A barrier layer, for example, a non-woven layer or additional batt layer, may be inserted below the surface to prevent the filler material from penetrating to the surface. U.S. Pat. No. 4,565,735 (Murka) describes a felt which consists of at least two types of batt fiber, one being of lower melt material and being applied in a lower quantity than the other and then is melted. The object is to give a felt with improved wear and compaction resistance.

### SUMMARY OF THE INVENTION

It is an object of the present invention to provide an industrial fabric which has improved resistance to rewet, and improved smoothness and wear resistance. It is a further object to provide an industrial fabric which has improved resistance to fiber shedding, superior macro and micro scale pressure uniformity, and is more economical to apply and process more consistently.

In accordance with one embodiment of the present invention there is provided a method of making an industrial fabric including the steps of providing a base layer, at least one batt layer, and at least one polymeric film layer, the method further including the steps of needling the layers and then thermoforming at least one polymeric layer.

Needling results in perforation of the polymeric film layer enabling anchoring of the batt fibers therethrough. The subsequent thermoforming of that layer leads to at least partial encapsulation of the surrounding batt fibers and cross-over points thereof. This gives improved locking of the fibers of the batt together, thereby reducing shedding. Furthermore, the combination of the batt fibers and polymeric film provide a resistance to re-wet and hence superior sheet dryness when the fabric is used for paper machine clothing. It also blocks the backflow of filtered substances in other applications. In comparison to the papermaking fabric described in U.S. Pat. No. 5,372,876, the present fabric, when used as a papermaking fabric, has been found to provide a fabric with superior fiber bonding and wear resistance, with enhanced surface/pressure uniformity and contact area for improved sheet smoothness. It is intended that the term “thermoforming” not only covers fully melting the plastics layer, but also the supplying of enough thermal energy to soften, that is deform, that layer sufficiently to enable at least partial encapsulation of the batt fibers. The polymeric film layer may be provided under at least one layer of batt and/or on at least one layer of batt.

In another embodiment the polymeric film layer is beneath a fine, uniform, fibrous diffusion layer, which forms a surface layer. This has the advantage that once needled and thermoformed, the polymeric partially encapsulates and anchors the surface fibers, providing a reduction in shedding in this region and also an improved surface wear resistance.

For hot end use applications, a polymeric film material with a higher melting point may be used, for example, a material such as an ether based polyurethane. This has the advantage of minimal degradation, thereby maintaining bonding and fiber adhesion in the structure. The permeability of the fabric can be controlled by varying the thickness and quantity of polymeric film layers used, as well as by adjusting the needling procedure, that is the number of punches per unit area, and the amount and coarseness of the batt driven through. The heat setting conditions, which may include the use of compression from a calender can also be used to adjust the permeability of the fabric to the required level, by altering the degree of tension/compressive forces present during high temperature applications.

In accordance with another embodiment of the present invention there is provided an industrial fabric including a base layer, a batt layer and at least one low-melt polymeric film layer, which has been needled into the batt layer and subsequently thermoformed to at least partially encapsulate fibers of that batt layer. The polymeric film layer may have a melting point of less than 215° C. Preferably the batt layer forms a surface layer of the fabric.

Preferably at least two batt layers are provided with the polymeric film layer being located under at least one of the batt layers. The polymeric film layer may be an elastomeric, thermoplastic polyurethane film. The film layer may have a thickness in the region of 0.05 mm. Polyurethane has the advantage that it has a lower melting point than that of the nylon fibers usually used to form the various batt layers, whilst still having a melting point which is above 100° C. thereby enabling continuous service of the fabric at relatively high temperatures without melting the polyurethane during use. Furthermore, being an elastomer, polyurethane maintains its original properties even after repeated melt/cool process cycles and it's high melt viscosity prevents it from “flowing” excessively at high temperatures.

The polymeric film layer may be perforated and/or may include a filler. The polymeric film layer may be of a multi-layer construction with at least two layers thereof having different characteristics.

The fabric includes a plurality of polymeric film layers, and in one embodiment at least two of the layers have different characteristics.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic view showing the production of an industrial fabric constructed in accordance with one embodiment of the present invention;

FIG. 2 is a scanning electron microscope photograph showing a detail of the constructed fabric of FIG. 1 illustrating the needled and subsequently molten plastics film;

FIG. 3 is a scanning electron microscope view of the paper contacting the surface of the fabric of FIG. 2;

FIG. 4 is a comparative graphical representation illustrating density variations throughout the width of the constructed fabric of FIG. 1; and

FIG. 5 is a schematic view of the layers in an industrial fabric before they are needled and heat set in accordance with another embodiment of the present invention.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

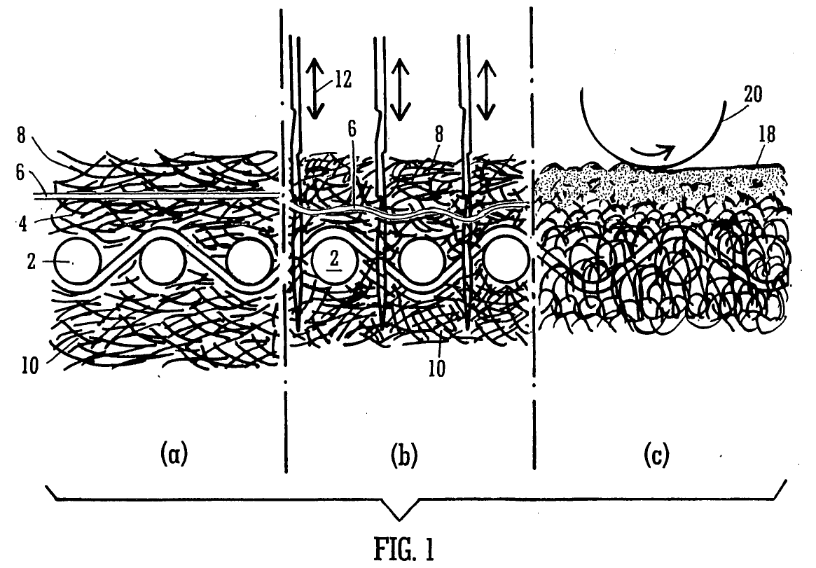

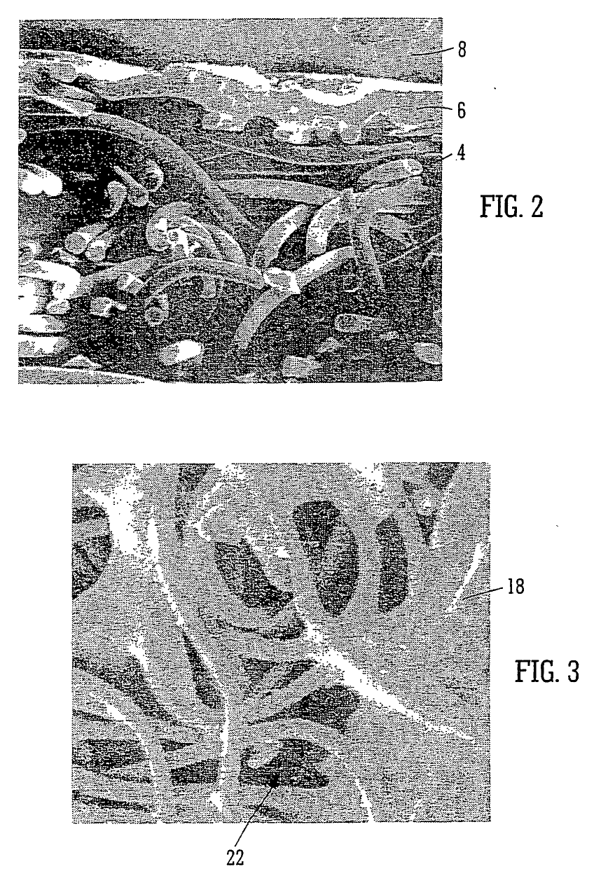

Referring now to the drawings and more particularly to FIG. 1(a), an industrial fabric constructed in accordance with an embodiment of the present invention includes a base layer 2, a first upper batt layer 4, a fine 0.051 mm (0.002 inch) thick elastomeric, a thermoplastic polyurethane film layer 6, an uppermost batt layer 8, and a lower batt layer 10. Polyurethane film layer 6 has a lower melting point than the other layers. These layers are joined, as best illustrated in FIG. 1(b), by needling 12 the layers together. Needling causes the individual fibers of the batt layers to intermingle and to link through base layer 2 to lock the layers together. Furthermore, the needling action perforates polyurethane film 6 to give a more open structure, through which the batt fiber is driven. As best illustrated in FIG. 1(c), the upper paper contacting surface of fabric 18 is heated at 200° C. using cylinder 20, this heat is sufficient to melt the lower melting point needled polyurethane film 6 only. This heat permeates through the fabric to melt needled film 6 and causes it to flow upwards towards upper surface 18 of upper batt layer 8. As best illustrated in FIGS. 2 and 3, once cooled the then needled and melted film 6 encapsulates the surrounding batt fibers and cross-over points thereof.

The fibers of upper batt layer 8 have a partial polyurethane coating, which better interlocks the individual fibers thereof to provide a cohesive structure less prone to fiber shedding. Gaps 22 within the coated fibers nevertheless present a porous layer.

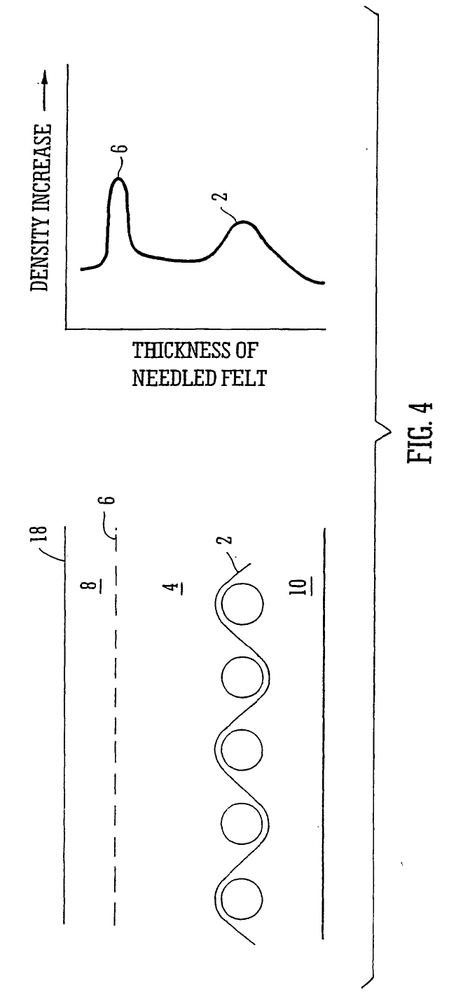

As best illustrated in FIG. 4, in the region of the needled and thermoformed film layer 6 there is an increase in the density of the fabric, which means that it is more difficult for expressed water to pass through the fabric in this particular region. However, when in use the fabric passes through the nip and is placed under very high pressure enabling expressed water, from the paper sheet carried on the fabric, to be more readily forced into and through the fabric. When the fabric emerges from the nip, the pressure of the nip is relieved, the fabric recovers, and the needled and thermoformed film layer 6 thereby once again presents a structure which is more difficult for the water to pass through. In this manner, the water is not able to force its way back through the fabric, that is, through this denser region to upper surface 18, so re-wet of a paper sheet is minimized. The encapsulated and anchored batt fibers of the present invention give greater pressure uniformity due to the more homogenous surface thereof, thus enabling more water to be squeezed out of a paper sheet transported thereon. In fact, experimental results have demonstrated that a fabric constructed in accordance with the present invention produced a paper sheet having an increase in sheet dryness of 1.8%, when compared to a paper sheet produced by a fabric constructed in accordance with U.S. Pat. No. 5,372,876.

U.S. Pat. Nos. 5,571,590 and 5,731,063 (Appleton Mills) describe the fusing/butt joining of plastics film supplied in narrow rolls to form full size endless loops. The film of the present invention can be joined in the manner described in these prior patents, but has the additional advantage that the actual joint will not be evident after heat and pressure has been applied during the heat thermo-setting process.

A fabric constructed in accordance with the present invention (Sample A) was tested and compared to a control sample fabric (Sample B) which contained equivalent layers, however the film had not been thermoformed in this control sample, and a second control sample (Sample C), which contained equivalent layers with the exception that the film layer was omitted. The permeabilities of Samples A, B and C were measured on a Frazier permeameter with 12.7 mm (0.5″) water gauge pressure. The permeabilities of Sample B and Sample C were 2.8 litres/m²/sec and 8 litres/m²/sec respectively. This demonstrates that the initial addition of the thin film of polyurethane, which is needled but not thermoformed, results in a fabric which has a significant reduction in permeability, thereby undesirably reducing the flow of expressed water therethrough. However, the permeability of Sample A, constructed in accordance with the present invention, is increased to 5.7 litres/m²/sec, giving a fabric with a permeability not significantly lower than that of control Sample C. Therefore, a fabric constructed in accordance with the invention has made only a slight compromise in permeability, whilst having the advantage of reduced fiber shedding, a more homogenous surface and a reduced incidence of re-wet.

It was expected that thermoforming of the polyurethane film would severely reduce the permeability, however tests show that with a sufficiently thin film the fabric remains open due to the vertical and horizontal migration of the polyurethane melt and it's ability to actually wet the batt fibers.

Although the film layer has been described as being provided between two upper batt layers, the film can alternatively be provided on uppermost surface 18 before it is joined by needling and then subsequently thermoformed. Although two upper batt layers have been described, several such layers may be provided and also more than one film layer can be provided on, or between adjacent batt layers. Additional film layers may be provided between or on adjacent batt layers. Although a lowermost batt layer has been illustrated, this can be omitted, or equally consist of several such layers. A film may also be provided between the lower batt layer(s), or immediately adjacent to the base layer. Although in the described embodiment the base fabric has been illustrated as a woven layer, this could be a non-woven layer, for example a porous film can be employed.

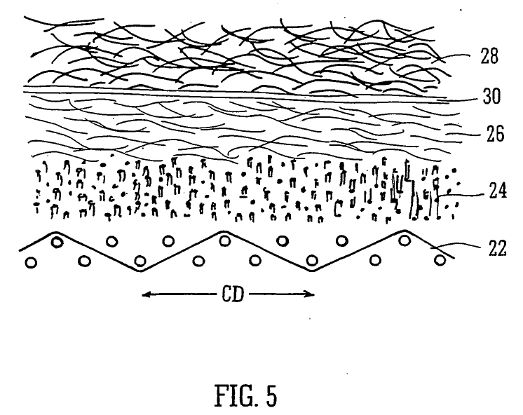

In the embodiment illustrated in FIG. 5, the industrial fabric includes a woven base cloth 22, batt layers 24, 26, and 28, and a plastics layer 30. Batt layer 24 includes a uniform, stiff, laminate non-woven batt structure, which is substantially aligned in the machine direction (MD) of the fabric. Batt layer 24 includes 0.1 mm (0.004″) thick bi-axial non-woven fibers. Batt layer 24 both diffuses and masks the base cloth. Batt layer 26 includes substantially cross-machine (CD) orientated fibers having a dtex of 17 and which by way of needling bonds base cloth 22 and batt layer 24 together, this also diffuses and masks the coarser machine direction orientated fibers of batt layer 24. Batt layer 28 includes a matrix of relatively fine batt fibers of 3.3 dtex. Batt layer 28 supports the sheet and facilitates the ease of water movement from the sheet into the press fabric.

Although the film layer has been described as being an elastomeric, thermoplastic polyurethane film, the film layer can include other types of plastics, for example other types of thermoplastic polymers; thermoplastic resin and/or elastomer, or a cross linkable resin and/or elastomer. Additionally, the film layer may contain fillers such as release agents, for example, fluorinated polymers and polysiloxanes, or inorganic fillers, adhesion promoters, foamable fillers etc. The film layer can be of a multi-layer construction with each layer providing unique properties, such as, melting temperature, elasticity, hydrophilic and hydrophobic characteristics influencing water movement in and out of the composite structure, barrier properties, etc. Further, the film layer may also be of a multi-layer construction with varying hardness. The film may be pre-perforated. The type of material and properties thereof can be selected depending on the required use of the fabric in terms of level of the permeability required or the possible degree of hydrophobic properties required.

Although the specific example has been described in relation to a fabric suitable for use as a papermaker's belt, which could be seamed or endless, such fabrics can also be used in other phase separation applications, such as filtration.

Although, the specific thickness of film has been described, it is to be understood that other thickness of film can be employed.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method of making an industrial fabric, comprising the steps of:
providing a base layer, at least one batt layer, and at least one polymeric film layer;
needling said layers; and
thermoforming said at least one polymeric film layer.

2. The method of claim 1, wherein said polymeric film layer is provided adjacent to said at least one layer of batt.

3. The method of claim 1, wherein said polymeric film layer is beneath a fine, uniform, fibrous diffusion layer, said diffusion layer forming a surface layer.

4. The method of claims 1, wherein said polymeric film layer is an ether based polyurethane.

5. An industrial fabric, comprising;
a base layer;
a batt layer; and
at least one low-melt polymeric film layer which has been needled into said batt layer and subsequently thermoformed to at least partially encapsulate fibers of said batt layer.

6. The industrial fabric of claim 5, wherein said polymeric film layer has a melting point of less than 215° C.

7. The industrial fabric of claim 5, wherein said batt layer forms a surface layer of the fabric.

8. The industrial fabric of claim 5, further comprising another batt layer, said polymeric film layer being located under at least one of said batt layers.

9. The industrial fabric of claim 5, wherein said polymeric film layer is an elastomeric, thermoplastic polyurethane film.

10. The industrial fabric of claim 5, wherein said polymeric film layer has a thickness of approximately 0.05 mm.

11. The industrial fabric of claim 5, wherein said polymeric film layer at least one of is perforated and includes a filler.

12. The industrial fabric of claim 5, wherein said polymeric film layer is of a multi-layer construction having at least two layers thereof, each of said at least two layers having different characteristics.

13. The industrial fabric of claim 5, wherein said fabric includes a plurality of polymeric film layers.

14. The industrial fabric of claim 13, wherein at least two of said plurality of polymeric film layers have different characteristics.
